(19) United States
(12) Patent Application Publication
(10) Pub. No.: US 2026/0153418 A1
(43) Pub. Date: Jun. 4, 2026

(54) CONTROLLING SAMPLE DILUTION FROM INJECTION APPARATUS TO FLOW CELL FOR MEASURING MOBILITY OF SAMPLE

(71) Applicant: Wyatt Technology, LLC, Goleta, CA (US)

(72) Inventors: Shivakumar Ramini, Newbury Park, CA (US); Anthony John Clemens, Goleta, CA (US); Steven P. Trainoff, Santa Barbara, CA (US)

(21) Appl. No.: 19/408,732

(22) Filed: Dec. 4, 2025

Related U.S. Application Data
(60) Provisional application No. 63/727,940, filed on Dec. 4, 2024.

(51) Int. Cl. G01N 1/38; G01N 15/10; G01N 15/1404

(52) U.S. Cl. CPC G01N 1/38; G01N 15/1404; G01N 2001/387; G01N 2015/1027

(57) ABSTRACT

Systems and methods for controlling sample dilution in an analytical instrument system comprise transmitting an injection command to an autosampler to inject a predetermined volume of air into a sample tubing coupled to an analytical instrument; and transmitting, subsequent to the injection of the predetermined volume of air, a fill command to the autosampler to aspirate a volume of sample into the sample tubing, wherein the predetermined volume of air is configured to form an immiscible barrier between the volume of sample and a solvent within the sample tubing.

### RELATED APPLICATION

This application is a non-provisional patent application claiming priority to U.S. Provisional Patent Application No. 63/727,940, filed Dec. 4, 2025, titled “Controlling Sample Dilution from Injection Apparatus to Flow Cell for Measuring Mobility of Sample,” which is incorporated herein by reference in its entirety.

### FIELD OF THE INVENTION

The disclosed technology relates to plug flow control for measuring electrophoretic mobility using light scattering techniques. More particularly, the disclosed technology relates to improving the measurement of electrophoretic mobility in a flow-based system by establishing an ideal “plug flow” of the sample.

### BACKGROUND

Light scattering instruments such as electrophoretic light scattering (ELS) and dynamic light scattering (DLS) instruments often rely on an autosampler for sequentially inserting plugs of precisely defined volumes of multiple samples through a flow cell which delivers them to a laser beam, allowing for analysis and measurement. In the case of ELS instruments, measurements can be taken by detecting the movement, or electrophoretic mobility from which the zeta potential can be derived, of the samples under an applied electric field. DLS instruments, on the other hand, measure the size of particles without the need for an applied electric field. However, both DLS and ELS measurements can be used to measure the various physical properties of the sample as the sample flows through the flow cell.

For high quality measurements, it is important that the autosampler inject a plug flow, namely, a sample having a constant concentration and conductivity, for the duration of the experiment. However, dilution with the solvent can change the buffer conditions around the sample molecules and result in an inaccurate determination of the mobility and zeta potential.

### SUMMARY

In one aspect, a computer-implemented method for controlling sample dilution in an analytical instrument system, comprises transmitting an injection command to an autosampler to inject a predetermined volume of air into a sample tubing coupled to an analytical instrument resulting in an air injection; and transmitting a fill command to the autosampler to aspirate a volume of sample into the sample tubing, wherein the predetermined volume of air is configured to form an immiscible barrier between the volume of sample and a solvent within the sample tubing.

In some embodiments, the method further comprises transmitting a run command to the autosampler to run degassed fluid through the sample tubing in response to the injection command.

In some embodiments, the analytical instrument is selected from the group consisting of an electrophoretic light scattering (ELS) instrument, a light scattering (LS) instrument, a viscometer, a field-flow fractionation (FFF) instrument, and a differential refractive index (dRI) detector.

In some embodiments, an inner diameter of the tubing is selected based on the volume of air to be injected, wherein minimizing the inner diameter of the tubing provides advantages including faster dissolution of air bubbles, while balancing against increased flow impedance and autosampler operational limits.

In some embodiments, air injection is performed subsequent to aspirating the volume of sample.

In some embodiments, air injection is performed in response to filling the volume of sample into the sample tubing.

In another aspect, an autosampler system for controlling sample dilution in analytical measurements comprises an injection loop comprising a column having a tubular housing with an inlet and an outlet; and a plurality of closely packed spherical beads disposed within the tubular housing, wherein the beads are configured to disrupt parabolic Poiseuille flow and create a tortuous flow path with multiple interstitial flow channels.

In some embodiments, a size of the beads ranges from 20 micron and 400 microns. In some embodiments, the size is between 200 microns and 400 microns. In some embodiments, the size is between 43 microns and 80 microns.

In some embodiments, the autosampler further comprising a computer processor that generates an injection command to inject a volume of air into the injection loop and that transmits in response to the sending, a fill command to the autosampler system to fill a requested volume of a sample into the sample tubing, whereby the volume of air forms a barrier between a sample and a solvent in the tubular housing. In some embodiments, the processor sends a run command to the autosampler system to run degassed fluid through the tubular housing in response to the transmitting to remove or dissolve bubbles from the tubular housing.

In some embodiments, the autosampler system further comprises a computer processor that transmits a fill command to fill a requested volume of a sample into the tubular housing; and sends in response to the transmitting an injection command to the autosampler system to inject a volume of air into the sample tubing, whereby the volume of air forms a barrier between the sample and a solvent in the tubing.

In another aspect, a system for controlling sample dilution in analytical measurements comprises an autosampler configured to inject samples into sample tubing; sample tubing coupled between the autosampler and an analytical instrument; and a computer processor configured to transmit commands to inject a predetermined volume of air into the sample tubing to form an immiscible barrier that maintains separation between a sample and a carrier solvent during transport.

In another aspect, a computer-implemented method comprises sending an injection command to an autosampler to inject a volume of air into a sample tubing (e.g., 50 uL at 35 bar) coupled to an instrument including an autosampler; and transmitting, in response to the sending, a fill command to the autosampler to fill a requested volume of a sample into the sample tubing, whereby the volume of air forms a barrier between the sample and a solvent in the tubing.

In some embodiments, an inner diameter of the column is chosen to induce the plug flow.

In some embodiments, the method further comprises sending a run command to the autosampler to run degassed fluid through the sample tubing in response to the transmitting to remove or dissolve bubbles from at least the tubing, including a sample cell of the instrument.

In some embodiments, the instrument is selected from a group consisting of an ELS instrument, a light scattering (LS) instrument, and a viscometer, FFF, and dRI.

In some embodiments, a size of the tubing is chosen with respect to the volume of air.

In another aspect, a computer-implemented method comprising transmitting a fill command to an autosampler to fill a requested volume of a sample into sample tubing coupled to an instrument; and sending, in response to the transmitting, an injection command to the autosampler to inject a volume of air into the sample tubing (e.g., 50 uL at 35 bar), whereby the volume of air forms a barrier between the sample and a solvent in the tubing.

In some embodiments, the method further comprises transmitting a run command to the autosampler to circulate degassed fluid through the sample tubing, the run command being configured to remove or dissolve bubbles from the sample tubing.

In some embodiments, the instrument is selected from a group consisting of an ELS instrument, a light scattering (LS) instrument, and a viscometer, FFF, and/or dRI.

In some embodiments, a size of the tubing is chosen with respect to the volume of air.

In another aspect, an autosampler comprises: a column of packed beads to induce plug flow in an injector tubing.

In some embodiments, a size of the beads ranges from 20 micron to 400 microns.

In some embodiments, the size is between 200 microns and 400 microns. In some embodiments, the size is between 43 microns and 80 microns.

In some embodiments, the autosampler further comprises air gap implementation.

In some embodiments, an inner diameter of the column is chosen to induce the plug flow.

In another aspect, a system comprises an autosampler; and a computer processor that sends an injection command to the autosampler to inject a volume of air into a sample tubing, e.g., 50 uL at 35 bar, coupled to an instrument and that transmits in response to the sending, a fill command to the autosampler to fill a requested volume of a sample into the sample tubing, whereby the volume of air forms a barrier between the sample and a solvent in the tubing.

In some embodiments, the processor sends a run command to the autosampler to run degassed fluid through the sample tubing in response to the transmitting to remove or dissolve bubbles from at least the tubing and/or from a sample cell of the instrument.

In another aspect, a system comprises an autosampler; and a computer processor that transmits a fill command to the autosampler to fill a requested volume of a sample into sample tubing coupled to an instrument; and sends in response to the transmitting an injection command to the autosampler to inject a volume of air into the sample tubing, whereby the volume of air forms a barrier between the sample and a solvent in the tubing.

In some embodiments, the computer processor is further configured to transmit a run command to the autosampler to circulate degassed fluid through the sample tubing, the run command being configured to remove or dissolve bubbles from the sample tubing.

In another aspect, an apparatus performs a method comprising sending an injection command to an autosampler to inject a volume of air for a pre-aspirate air gap into a sample tubing coupled to an instrument such as an autosampler; and transmitting, in response to the sending, a fill command to the autosampler to fill a requested volume of a sample into the sample tubing, whereby the volume of air forms a barrier between the sample and a solvent in the tubing.

In some embodiments, the method further comprises sending a run command to the autosampler to run degassed fluid through the sample tubing in response to the transmitting to remove or dissolve bubbles from at least the tubing, wherein in some embodiments also from a sample cell of the instrument.

In another aspect, an apparatus performs a method comprising: transmitting a fill command to an autosampler to fill a requested volume of a sample into sample tubing coupled to an instrument; and sending, in response to the transmitting, an injection command to the autosampler to inject a volume of air into the sample tubing, e.g., 50 uL at 35 bar, whereby the volume of air forms a barrier between the sample and a solvent in the tubing.

In some embodiment, the method further comprises sending a run command to the autosampler to run degassed fluid through the sample tubing in response to the sending to remove or dissolve bubbles from at least the tubing, for example, also from a sample cell of the instrument.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of a sample measurement system in which embodiments of the present inventive concept can be practiced.

FIG. 2 is a diagram of a system that includes a syringe pump providing sample plugs to a light scattering instrument in which embodiments of the present inventive concept can be practiced.

FIG. 3 is a graph illustrating intensity and conductivity measurement results performed by the system of FIG. 2.

FIG. 4 is a graph illustrating intensity and conductivity measurement results performed by the system of FIG. 1.

FIG. 5 is a schematic illustration of a Taylor-Aris dispersion over time.

FIG. 6 is a schematic illustration of a Poiseuille flow in an injection loop over time.

FIG. 7 is a graph illustrating a comparison of concentration trace results from an inline ultraviolet (UV) detector.

FIG. 8 is a graph illustrating an effect of an air gap applied to a sample volume, in accordance with some embodiments.

FIG. 9 is a diagram of a delay column comprising a plurality of packed beads, in accordance with other embodiments.

FIG. 10 is a diagram of a system including a detector stream of a field flow fractionization (FFF) channel, in accordance with other embodiments.

FIG. 11 is a flow diagram illustrating a method that includes inserting an air gap between a sample and solvent, in accordance with other embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

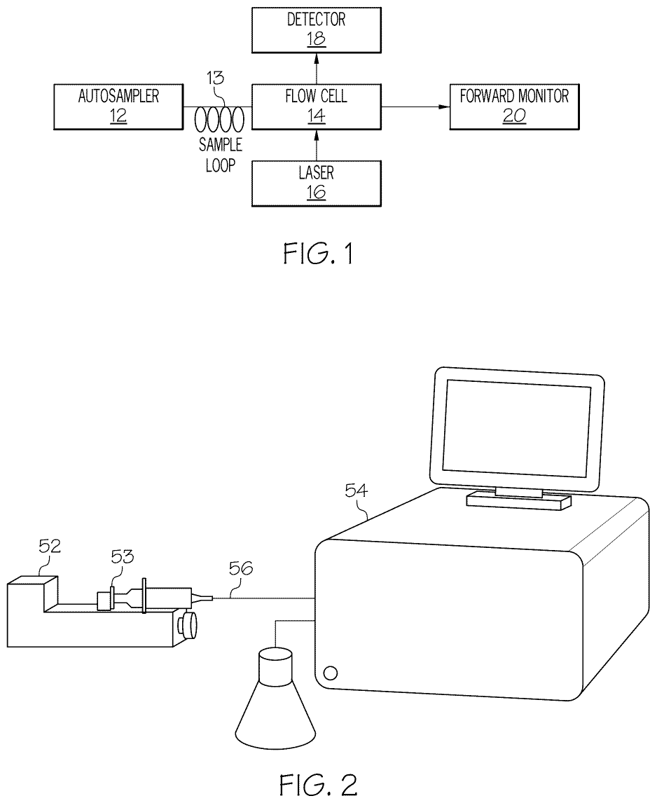

Referring to an embodiment illustrated in FIG. 1, as part of electrophoretic light scattering (ELS) and dynamic light scattering (DLS) measurements, intensity of scattered light and conductivity of the sample are measured as the sample received from an autosampler 12 and injection or sample loop tubing 13, which in turn delivers sample to a flow cell 14 or the like. The autosampler 12 serves as an automated sample introduction system that sequentially delivers precise volumes of multiple samples for analysis. The injection or sample loop 13 comprises a length of tubing that temporarily stores a predetermined volume of sample before injection into the flow cell 14. For example, a source tubing used in embodiments herein may accommodate 50 μL at 35 bar, but other dimensions may equally apply. The flow cell 14 is positioned within the optical path of a laser beam and includes transparent windows that allow the laser light to pass through the flowing sample while enabling detection of scattered light at various angles.

During ELS measurements, electrodes positioned within or adjacent to the flow cell 14 apply an electric field across the sample, causing charged particles to migrate with a velocity proportional to their electrophoretic mobility. The scattered light intensity provides information about particle concentration and size distribution, while conductivity measurements monitor the ionic strength of the buffer solution, which is critical for accurate zeta potential calculations. In DLS measurements, the same intensity measurements are analyzed for temporal fluctuations caused by Brownian motion of particles, allowing determination of particle size without the need for an applied electric field.

As shown in another embodiment illustrated in FIG. 2, an ideal plug flow can be determined by injecting the sample with a syringe pump 52. The plug flow can be determined by the geometry of the flow cell 14 (FIG. 1) or flow cell (not shown) inside detector 54 (FIG. 2). The syringe pump 52 provides direct, continuous injection of sample at a controlled flow rate, typically ranging from 0.1 to 10 mL/min, which eliminates the sample storage and valve switching steps that are inherent in autosampler-based injection systems. This direct injection approach bypasses the injection loop entirely.

The geometry of the flow cell 14 plays a critical role in defining the quality of the plug flow that can be achieved. Flow cells designed for light scattering measurements typically have a rectangular or cylindrical cross-section with dimensions optimized to balance optical path length, sample volume requirements, and flow characteristics. The flow cell geometry determines the minimum rise and fall times for concentration changes, as the sample must completely displace the previous fluid within the cell volume.

In the syringe pump configuration in FIG. 2, the sample maintains its original concentration and ionic strength throughout the injection process because there is no mixing with carrier solvent in an intermediate storage volume. This results in the sharp, rectangular concentration profile characteristic of ideal plug flow, where the sample concentration remains constant during the measurement period and transitions rapidly between sample and solvent phases are limited only by the flow cell geometry rather than by dispersion in the injection pathway.

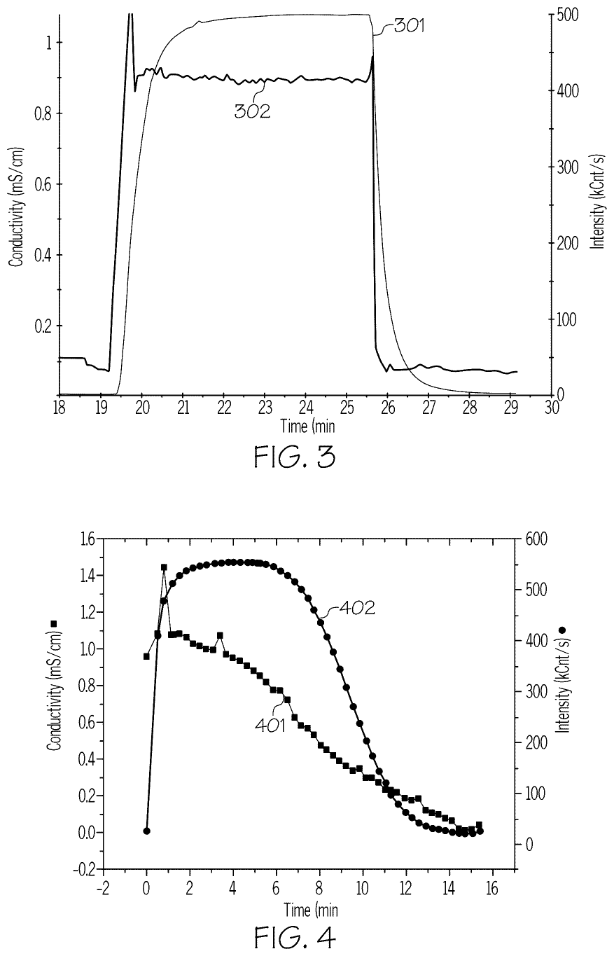

As shown in FIG. 3, scattered light intensity is plotted as trace 302 and conductivity is plotted as trace 301. Until 19 minutes, deionized (DI) water is injected with a syringe pump 52 where the intensity 302 and the conductivity trace 301 remain close to zero. At around 19 minutes, the DI water syringe is swapped with a syringe holding a test sample, e.g., scattering samples in a salt buffer. The transition from DI water to the test sample results in an immediate increase in both scattered light intensity and solution conductivity as particles and ions enter the measurement zone. In this experiment, a test sample was injected until about 26 mins and switched back to DI water, creating a rectangular injection profile. The intensity plot 302 of FIG. 3 shows an almost instantaneous rise and fall in intensity, signifying an ideal plug flow with sharp transitions between sample and solvent phases. The slower ramp up and down in conductivity trace 301 is due to the sample cell geometry and the finite time required for complete fluid exchange within the cell volume, which sets the limit on the time scale of the rise and fall transitions that can be observed in the measurement system.

However, when a similar measurement is performed by injecting the sample using the autosampler 12 shown in FIG. 1, a large dilution effect is detected as shown in FIG. 4. Here, trace 401 shows the intensity of the scattering signal and trace 402 shows the conductivity of the sample as it flows through the cell 14. Clearly, the plug shape is deteriorated as the sample passes through the injection loop 13 before entering the sample cell 14, with the conductivity trace exhibiting a brief plateau while the count rate, as seen by the back-scatter DLS detector, shows continuous decay. The deterioration represents a fundamental departure from ideal plug flow behavior, producing a broadened, asymmetric peak where the sample concentration never reaches a stable plateau due to continuous dilution throughout the injection process. The long tailing observed in both traces is particularly problematic for quantitative measurements, as sample continues to elute long after the main sample plug has passed, leading to baseline drift and potential interference with subsequent measurements. The peak broadening and asymmetry directly compromise the accuracy of electrophoretic mobility measurements since ELS measurements rely on detecting small changes in particle velocity under an applied electric field, and any variation in sample concentration or buffer conditions during the measurement period introduces systematic errors that not only reduce signal-to-noise ratio but also alter the ionic strength of the solution, directly affecting the calculated zeta potential.

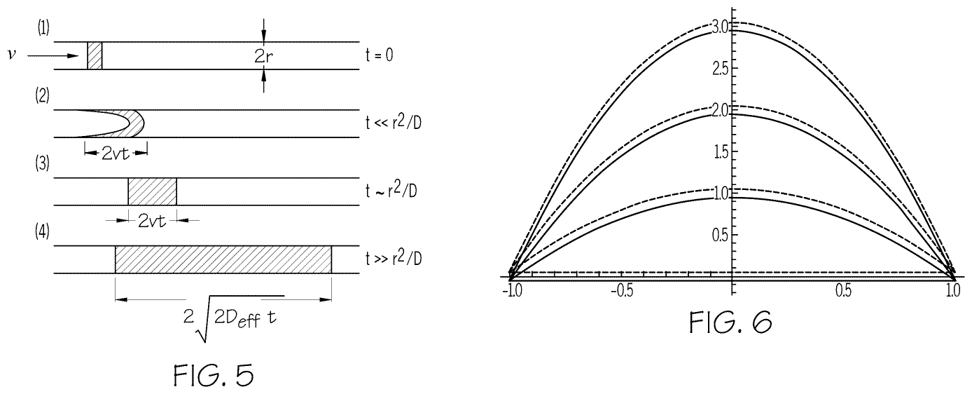

The results illustrated in the graph of FIG. 4 can be explained by reviewing the various limits a Taylor-Aris flow as shown in FIG. 5. In FIG. 5, r is the radius of the tube (sample loop 13 in FIG. 1 or PEEK tubing 56 in FIG. 2), D is the diffusion constant of the fluid under flow, and v is the velocity of the fluid. Line (1) of the Taylor-Aris dispersion in FIG. 5 illustrates an initial bolus (t=0) where sample is injected into the carrier stream in the tube. When the sample is loaded into the injection loop 13, it displaces the solvent inside the loop 13. The Poiseuille flow in the injection loop 13 causes a parabolic velocity profile (shown in FIG. 6) that is maximal in the center and goes to zero on the walls of the tube. This is shown in line (2) in FIG. 5, where t<<r²/D. As the sample moves through the mixing zone and the reaction zone, the width of its flow profile increases as the sample disperses into the carrier stream. Dispersion can result from a combination of convection and diffusion due to the concentration gradient between the sample and the carrier stream. Line (2) in FIG. 5 illustrates the bolus having a parabolic flow profile after an elapsed time when the effect of diffusion is minor in comparison with dispersive effect of the flow. Line (3) illustrates a time where a finite radial/transverse diffusion has already occurred. Line (4) illustrates a time when diffusion already strongly influences dispersion and interplays with a convective transport. Because the velocity on the walls is zero, the injection stretches with a parabolic profile. This implies that the average concentration is reduced, which results in the tailing observed in FIG. 4. Because of this stretching effect, even for long times, some sample is retained on the walls. The only way that sample can mix across the tube is through diffusion. The time scale for diffusion to move a sample from the wall to the middle of the channel is given by

$$t ∼ \frac{{r}^{2}}{D} .$$

(line 3 of FIG. 5). For times shorter than this, the concentration profile is dominated by stretching. For times longer than this, it is dominated by diffusion, which is well predicted according to the Taylor-Aris dispersion theory.

For example, consider the times scales for an injection of Bovine Serum Albumen (BSA). BSA dissolved in phosphate buffer has a diffusion constant of 6.7×10⁻⁶ cm²/sec, and the autosampler injector tubing 13 has an internal radius of 0.5 mm, so that, with respect to FIG. 5 line 2,

$$t = \frac{{r}^{2}}{D} = 373 sec = 6.2 min .$$

The time scale of a typical injection is around 5 minutes, so the system is dominated by stretching and the effects of diffusion do not dominate.

In brief overview, embodiments of the present inventive concept includes different approaches to establish a plug flow into a measuring device, such as a zeta potential measuring device with an autosampler injection. These approaches address the fundamental challenge of maintaining sample integrity during the injection process, where conventional autosampler systems suffer from Taylor-Aris dispersion effects that compromise measurement accuracy. The measuring device may comprise any analytical instrument that benefits from receiving a well-defined sample plug with minimal dispersion, including but not limited to electrophoretic light scattering (ELS) instruments for zeta potential determination, dynamic light scattering (DLS) instruments for particle size analysis, multi-angle light scattering (MALS) detectors for molecular weight determination, viscometers for rheological measurements, and field-flow fractionation (FFF) systems for particle separation and characterization. The autosampler injection system typically comprises an injection valve, sample loop or storage volume, and associated tubing that connects the sample source to the analytical flow cell.

In a first embodiment, an air gap is injected between the sample and solvent so that it acts as a barrier and prevents dilution. This approach leverages the immiscible nature of the gas-liquid interface to create a physical separation that prevents the sample from mixing with the carrier solvent during transport through the injection system. The air gap method is particularly effective because it maintains the original sample concentration and buffer conditions throughout the injection process, thereby preserving the ionic strength and pH conditions that are critical for accurate electrophoretic mobility measurements.

In a second embodiment, instead of using a tube as an injection loop, a column is provided having a plurality of closely packed beads. This packed bed approach modifies the flow characteristics within the sample storage volume by creating a more uniform velocity profile compared to the parabolic Poiseuille flow that occurs in open tubing. The packed beads disrupt the laminar flow pattern and promote more uniform sample transport, thereby reducing the axial dispersion that leads to peak broadening and tailing in conventional injection systems.

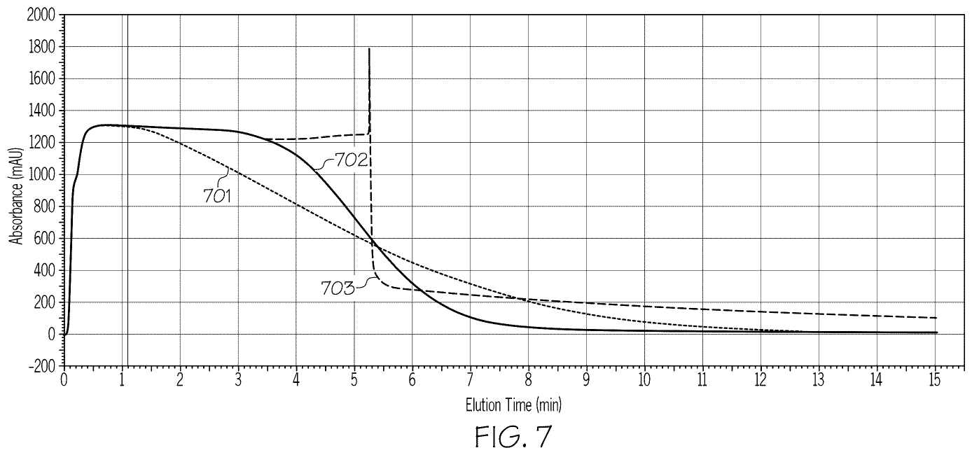

In the graph shown in FIG. 7, the shape of the plug is assessed by injecting the sample from an autosampler into an inline UV detector, which measures the concentration of the solute (absorbance) as the sample passes through.

It is desirable that an optimal volume of air be injected. Using a smaller inner diameter (ID) injection loop we can minimize the amount of air required to obtain optimal performance. An example of this would be using a 0.030″ ID injection loop instead of a stock 0.040″ ID injection loop. The inner diameter of the column can be chosen to induce the plug flow. Injecting a smaller amount of air is desirable, because smaller bubbles dissolve faster, and are easier to flush out of the cell than bigger ones. This reduces the risk of the injected bubble affecting the following measurement. As is well-known, a bubble in the flow cell may cause intermittent episodes of low light and large noise.

The critical parameter is the compressed bubble length, and that this length is greater than the ID of the tubing. If the compressed bubble length is smaller than the inner diameter of the tubing, then the liquid-gas-liquid interface will not be fully formed across the entire diameter of the tubing, which hurts performance. In some embodiments, a 50 uL bubble, but not limited thereto, is loaded into the sample loop at atmospheric pressure and introduced into the high-pressure flow regulated by a backpressure regulator at 500 psi or 34.5 bar, then assuming ideal gas law, the bubble will collapse to 1/34.5 of its volume. This means the compressed bubble's volume is ˜1.5 uL at 34.5 bar of pressure. Dividing by the cross-sectional area of the tubing, the compressed bubble's length can be calculated. For a 0.030″ (0.762 mm) ID tubing this compressed length is 3.22 mm, and for 0.040″ (1 mm) ID tubing this compressed length is 1.81 mm. This calculation is an approximation that assumes a perfect cylinder and does not include the radius of the meniscus of the two liquid-gas interfaces.

Regardless, due to the dependence of the compressed bubbles length on the cross-sectional area of the tube, and the requirement that the compressed bubble length must be greater than the inner diameter of the tube, these two reasons mean that using a smaller ID injection loop will minimize the amount of air required for optimal performance. Using this simplistic model, for the 0.030″ (0.762 mm) ID loop the optimal volume of air at atmospheric pressure is ˜12 uL, but for the 0.040″ (1 mm) ID loop it's ˜28 uL, which is 2.33× the amount of air.

In FIG. 7, trace 701 represents a plug shape with a length of tubing used as the injection loop, which represents a worse-case scenario. In particular, trace 701 exhibits the characteristic broadened, asymmetric peak shape with extensive tailing that results from the combination of convective dispersion and the retention of sample material along the tube walls where flow velocity approaches zero. This dispersion effect is particularly pronounced in longer injection loops or when using tubing with larger internal diameters, as both factors increase the residence time and the opportunity for sample spreading to occur.

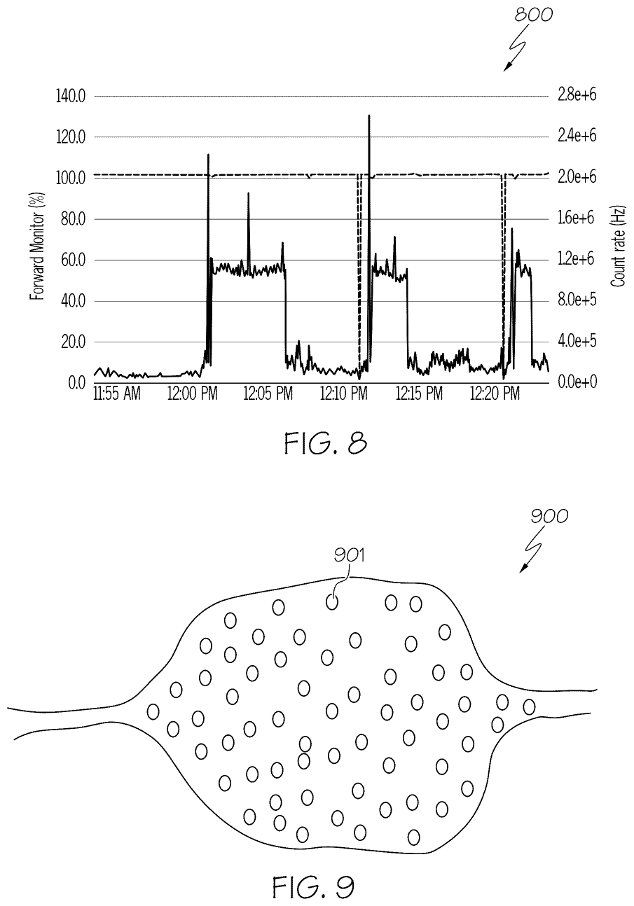

Trace 702 represents the plug shape when a column 900 with tightly packed beads 901 is used as the injection loop (shown in FIG. 9), which represents reasonable improvement to the plug shape. The packed beads 901 disrupt the laminar flow pattern and parabolic velocity profile characteristic of open tubing, creating more uniform sample transport through multiple flow paths with enhanced radial mixing. In some embodiments, a size of the beads ranges from 20 micron to 400 microns. In some embodiments, the size is between 200 microns and 400 microns. In some embodiments, the size is between 43 microns and 80 microns. While some dispersion still occurs due to tortuous flow paths and diffusion processes, the overall plug integrity is significantly better preserved, with reduced peak broadening and diminished tailing compared to the open tube configuration.

Lastly, trace 703 represents the plug shape with a length of the tubing as the injection loop, but introduces an air gap between the sample and solvent, which shows superior performance and preserves the plug flow in entirety. The air gap creates an immiscible barrier that prevents mixing between the sample and carrier solvent during transport. Trace 703 demonstrates the rectangular concentration profile characteristic of ideal plug flow, with sharp transitions limited primarily by flow cell geometry rather than injection pathway dispersion. This superior performance eliminates concentration gradients that drive diffusive mixing, maintaining uniform flow characteristics and preserving original sample properties for more accurate analytical results.

FIG. 8 is a graph 800 illustrating the effect of an air gap on sample volume, in accordance with other embodiments. The 0.030″ (0.762 mm) ID loop described in examples above is used to produce the graph 800. The plot shows successive injections of 500 μL, 250 μL, and 125 μL volumes, respectively. As shown, the forward monitor 20 (see FIG. 1) recovers after a brief drop showing a successful clearance of a deliberately injected air bubble. Sometimes, the air bubble is trapped in a corner far from the laser beam and is not detrimental to the measurement, which slowly gets dissolved away as degassed solvent is flushed through flow cell between the successive injections.

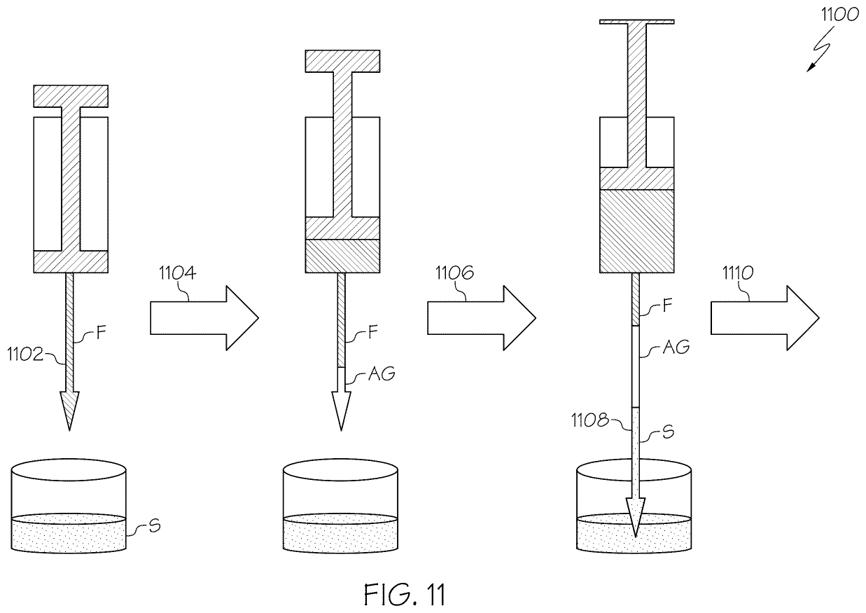

In some embodiments, an application of air gap injection can be extended to other systems where a uniform plug flow with minimal dispersion is desirable. Accordingly, the programmable air gap injection method, for example, shown and described with respect to FIG. 11, can be used to minimize the dispersion of the injection pathway for many different types of applications. The air gap injection technique finds particular application in electrophoretic light scattering measurements, where maintaining precise sample concentration and ionic strength is critical for accurate zeta potential determination. This includes both slow flow and stop flow measurement protocols, for example described in U.S. Provisional Patent Application No. 63/714,408 the contents of which are incorporated by reference herein in their entirety. In slow flow measurements, the sample moves continuously through the measurement cell at reduced velocities, allowing for extended data collection periods while minimizing the effects of sedimentation and thermal convection. Stop flow measurements involve halting sample movement entirely during data acquisition, which eliminates flow-induced artifacts but requires exceptional plug stability to maintain consistent sample properties throughout the measurement period. The air gap technique is particularly beneficial for these applications because any dilution or concentration gradient within the sample plug would directly affect the measured electrophoretic mobility and lead to systematic errors in the calculated zeta potential values. Beyond electrophoretic light scattering, numerous other analytical technologies could benefit from this programmable air gap injection technique, particularly those requiring precise sample delivery with minimal band broadening or dispersion effects.

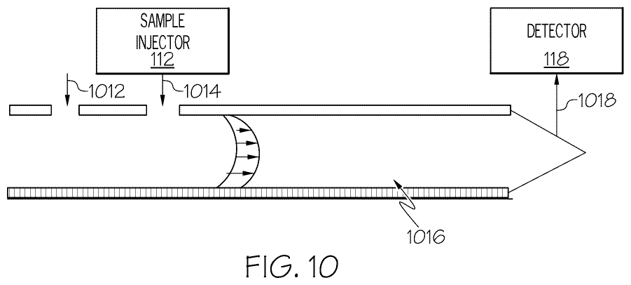

In some embodiments, one such other application may include field-flow fractionation, shown in FIG. 10, where there is a type of channel that could benefit from this programmable air gap injection method. Namely, the frit-inlet or dispersion inlet channel 1012, where the final peak width at elution is dictated by 3 factors, the dispersion of the tubing before the channel, or injection pathway, 1014, the dispersion of the channel itself 1016, and the dispersion of the tubing after the channel, or detector pathway, 1018. The injection pathway 1014 comprises the autosampler tubing and connections that transport the sample from the injection valve to the inlet of the dispersion inlet channel 1012, where Taylor-Aris dispersion effects can significantly broaden the sample plug before it enters the separation channel. The dispersion inlet channel 1012 itself introduces additional band broadening as the sample flows through the channel geometry, with dispersion characteristics determined by the channel dimensions, flow rate, and sample diffusion properties. The detector pathway 1018 includes the tubing and connections between the channel outlet and the analytical detector, which can contribute further to peak broadening, particularly if the pathway volume is large relative to the eluted peak volume. Using the programmable air-gap reduces the dispersion contribution before the channel 1014 to zero, thus improving performance and allowing for narrower peaks at elution, with higher plate counts and more efficient separation.

Higher plate counts enable separation of particles with smaller size differences, extend the useful size range, and provide more accurate size distribution measurements for polydisperse samples.

Experimental results show that lower injection flow rates reduce dispersion within the channel but increase dispersion in the tubing before the channel. The programmable air gap technique remedies this problem, allowing injection at lower flow rates with zero dispersion before the channel and improved dispersion within the channel, bringing dispersion inlet channel performance in line with focusing channels.

FIG. 11 is a flow diagram illustrating a method 1100 that includes inserting an air gap between a sample and solvent, in accordance with other embodiments. As described above, in some embodiments, an application of air gap injection can be extended to other systems where a uniform plug flow with minimal dispersion is desirable. Accordingly, the programmable air gap injection method 1100 be used to minimize the dispersion of the injection pathway for many different types of applications.

In step 1102, the loop is filled with mobile phase fluid. The mobile phase fluid, typically a buffer solution or carrier solvent, occupies the injection loop volume and serves as the baseline medium through which the sample will be transported. This mobile phase filling step 1102 may occur during system initialization or between sample injections to ensure the loop contains a known fluid composition before sample aspiration begins.

Following the mobile phase filling (1102), a step 1104, an air gap (AG) is aspirated from above the vial containing a sample(S), creating an immiscible barrier that prevents dilution during sample transport. In step 1104, an air gap is aspirated from above the sample vial.

In step 1106, the loop is partially filled with air. The volume of the air gap may be optimized based on system parameters including tubing dimensions, operating pressure, and sample volume requirements.

In step 1108, the sample(S) is filled into the tubing, where the sample is drawn into the injection loop while maintaining separation from the carrier solvent by the previously introduced air gap. The air gap acts as a physical barrier that preserves the original sample concentration and ionic strength conditions throughout the injection process.

In step 1110, the sample is injected into the analytical instrument, where the air gap continues to prevent mixing between the sample and carrier solvent during transport through the injection pathway. The loop is prepared for reverse flow injection method, which allows the sample to be injected in the opposite direction from which it was loaded into the loop, helping to maintain plug flow integrity necessary for accurate electrophoretic light scattering measurements, whether performed in slow flow or stop flow configurations as described in U.S. Provisional Patent Application No. 63/714,408.

The programmable nature of this air gap injection method 1100 allows for optimization of parameters such as air gap volume, timing, and positioning based on specific application requirements. This approach may be extended to various analytical systems where uniform plug flow with minimal dispersion is desirable, including other light scattering applications, chromatographic systems, and flow-based analytical instruments that benefit from precise sample delivery with reduced band broadening effects.

Other embodiments may equally apply. In some embodiments such as the method 1100, air is injected first in response to an injection command, then the sample is aspirated in response to a fill command. However, in other embodiments, the sample is filled first in response to a fill command, then air is injected in response to an injection command.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns.

### Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated, generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photo detector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is an SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam, usually from a laser source producing a collimated beam of monochromatic light, that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photo detectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to a zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity. The mobility, which is the ratio of the measured velocity to the applied electric field, is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived, for example, using either the Smoluchowski/Debye-Hückel approximations or the complete Henry function F(κa) to get from the mobility to a zeta potential.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for controlling sample dilution in an analytical instrument system, the method comprising:
transmitting an injection command to an autosampler to inject a predetermined volume of air into a sample tubing coupled to an analytical instrument resulting in an air injection; and
transmitting a fill command to the autosampler to aspirate a volume of sample into the sample tubing, wherein the predetermined volume of air is configured to form an immiscible barrier between the volume of sample and a solvent within the sample tubing.

2. The method of claim 1 further comprising transmitting a run command to the autosampler to circulate degassed fluid through the sample tubing in response to the injection command, and configuring the run command to remove or dissolve bubbles from the sample tubing.

3. The method of claim 1, wherein the analytical instrument is selected from the group consisting of an electrophoretic light scattering (ELS) instrument, a light scattering (LS) instrument, a viscometer, a field-flow fractionation (FFF) instrument, and a differential refractive index (dRI) detector.

4. The method of claim 1 wherein an inner diameter of the sample tubing is selected based on the predetermined volume of air to be injected, wherein minimizing the inner diameter of the tubing provides advantages including faster dissolution of air bubbles, while balancing against increased flow impedance and autosampler operational limits.

5. The method of claim 1, wherein the air injection is performed subsequent to aspirating the volume of sample.

6. The method of claim 1, wherein the air injection is performed in response to filling the volume of sample into the sample tubing.

7. The method of claim 1, wherein the predetermined volume of air is calculated based on a compressed bubble length that exceeds an inner diameter of the sample tubing when the air is subjected to system operating pressure, whereby the immiscible barrier extends across an entire cross-sectional area of the sample tubing to prevent liquid-to-liquid contact.

8. An autosampler system for controlling sample dilution in analytical measurements, the autosampler system comprising:
an injection loop comprising a column having a tubular housing with an inlet and an outlet; and
a plurality of closely packed spherical beads disposed within the tubular housing, wherein the plurality of closely packed spherical beads are configured to disrupt parabolic Poiseuille flow and create a tortuous flow path with multiple interstitial flow channels.

9. The autosampler system of claim 8, wherein a size of the plurality of closely packed spherical beads ranges from 20 micron and 400 microns.

10. The autosampler system of claim 9 wherein the size is between 200 microns and 400 microns.

11. The autosampler system of claim 10, wherein the size is between 43 microns and 80 microns.

12. The autosampler system of claim 8, further comprising a computer processor that generates an injection command to inject a volume of air into the injection loop and that transmits a fill command to the autosampler system to fill a requested volume of a sample into the injection loop, whereby the volume of air forms a barrier between the sample and a solvent in the tubular housing.

13. The autosampler system of claim 12, wherein the computer processor sends a run command to the autosampler system to run degassed fluid through the tubular housing in response to the transmitting of the fill command to remove or dissolve bubbles from the tubular housing.

14. The system of claim 12, further comprising a computer processor that transmits the fill command to fill a requested volume of a sample into the tubular housing; and sends in response to the transmitting an injection command to the autosampler system to inject a volume of air into the injection loop, whereby the volume of air forms a barrier between the sample and a solvent in the tubular housing.

15. A system for controlling sample dilution in analytical measurements, the system comprising:
an autosampler configured to inject samples into a sample tubing;
the sample tubing coupled between the autosampler and an analytical instrument; and
a computer processor configured to transmit commands to perform an air injection that includes an injection of a predetermined volume of air into the sample tubing to form an immiscible barrier that maintains separation between a sample and a carrier solvent during transport.

16. The system of claim 15, wherein the computer processor is further configured to transmit a run command to the autosampler to circulate degassed fluid through the sample tubing, the run command being configured to remove or dissolve bubbles from the sample tubing.

17. The system of claim 15, wherein the analytical instrument is selected from the group consisting of an electrophoretic light scattering (ELS) instrument, a light scattering (LS) instrument, a viscometer, a field-flow fractionation (FFF) instrument, and a differential refractive index (dRI) detector.

18. The system of claim 15, wherein an inner diameter of the sample tubing is selected based on the predetermined volume of air to be injected, wherein minimizing the inner diameter of the sample tubing provides advantages including faster dissolution of air bubbles, while balancing against increased flow impedance and autosampler operational limits.

19. The system of claim 15, wherein the air injection is performed subsequent to aspirating the sample.

20. The system of claim 15, wherein the air injection is performed in response to filling the sample into the sample tubing.
